(19) United States
(12) Patent Application Publication
(10) Pub. No.: US 2012/0306758 A1
(43) Pub. Date: Dec. 6, 2012

(54) SYSTEM FOR DETECTING A USER ON A SENSOR-BASED SURFACE

(75) Inventors: Randal J. Marsden, Edmonton (CA); Steve Hole, Edmonton (CA)

(73) Assignee: CLEANKEYS INC., Edmonton (CA)

(21) Appl. No.: 13/485,802

(22) Filed: May 31, 2012

Related U.S. Application Data
(60) Provisional application No. 61/491,662, filed on May 31, 2011.

(51) Int. Cl. G06F 3/041; G06F 3/02; G06F 3/01

(52) U.S. Cl. 345/168; 345/156; 345/173

(57) ABSTRACT

Systems and methods uniquely identify the user of the keyboard. An example of the present invention includes sensors capable of detecting the interaction of a user caused by their touch, vibration, proximity, and actuation of key switches. Unique characteristics such as typing style, touch signature, tap strength, and others can be determined using the multi-sensor keyboard in ways not possible on a conventional mechanical keyboard. Further, it is also useful to know when a change of keyboard users has occurred for the purpose of infection prevention in healthcare settings where cross-contamination via computer keyboards is prevalent.

### PRIORITY CLAIM

This application claims the benefit of U.S. Provisional Application Ser. No. 61/491,662 filed 31 May 2011, the contents of which are hereby incorporated by reference.

### BACKGROUND OF THE INVENTION

In the field of electronic communications, it is often desirable to know the identity of the user generating the communication. Many methods have been devised to identify a particular person, including simple username and password security all the way up to using biometric characteristics, such as fingerprints, voiceprints, or retinal scans. Because of the relatively higher cost and complexity of biometric security measures, the most common form of security employed today is username and password methods, which are almost always input using a keyboard. Unfortunately, keyboard-based security methods are relatively easy to compromise and there are many cases where a person's username and/or password have been stolen resulting in malicious criminal acts, including theft.

In U.S. Pat. No. 7,701,364 Zilberman describes an invention wherein the timing between keystrokes of a password forms part of the user authentication scheme. This provides an added level of security since even if a password was stolen, the speed and cadence at which that password is typed would be difficult to know or replicate. However, this approach only works for user authentication during a login event. It doesn't detect when more than one user has used the keyboard or computer during the same computing session.

In U.S. Pat. No. 7,069,187 Kondo et al. describes a solution to the problem of user changes during the same session, wherein keyboard operation is monitored on an on-going basis. The time it takes to press a key, release it, and press the next key is stored for each user and compared during typing on the keyboard. In theory, this yields a unique profile for each user that can be determined in real-time as the user types. The problem with this approach is it requires the user themselves to remain consistent in their typing style and cadence. Because the invention is based on timing of pressing and releasing keys, the user must press and release those keys the same each time. Pauses in typing due to thinking, for example, may throw off the cadence and cause the system to incorrectly identify a user change when there has been none. On a conventional switch-based keyboard, timing is the only parameter that can be measured, providing scant data to accurately identify a user on an on-going basis.

Beyond security needs, there are other applications where identifying the specific person using a keyboard is beneficial. For example, in a hospital or other healthcare setting, it is important to track the movement of healthcare workers and what they touch so-as to reduce the spread of harmful infections. Further, the computer becomes a risky point of infection cross-contamination in healthcare settings when it is shared between different users. As a way to combat the spread of infection, it would be very beneficial to know when the user of the keyboard has changed.

Identifying specific users based on input on conventional mechanical keyboards is difficult, as there is limited unique data available on these systems. Computer keyboards have traditionally consisted of a series of mechanical moving keys on which the user types, similar to how it was done previously on typewriters. In the days when Morse Code was a common form of communication, individual users developed unique styles, or “signatures” that could be recognized by experienced decoders who were listening as the message was being composed. However, in modern communication, a message is typically composed before sending and so the listener doesn't have the benefit of seeing and interpreting the input so-as to discern the originator of the message. Further, with mechanical keys, the amount of data available to uniquely identify users is limited; typically only typing speed can be used reliably.

### SUMMARY OF THE INVENTION

The present invention is a computer a human-computer interface device that incorporates numerous types of sensors that are used to uniquely identify the user of the device. These include sensors capable of detecting the interaction of a user caused by their touch, vibration, proximity, and actuation of key switches. Unique characteristics such as typing style, touch signature, tap strength, and others can be determined using the multi-sensor device in ways not possible on conventional human-computer interface devices such as a mechanical keyboard.

Unique identification of the user of an interface device is useful for security applications. There are many methods commonly available to first authenticate a user of a computer and then provide authorization to that identity. The present invention provides continuous verification of the authenticated identity. For example, if a user has logged into a computer with the proper credentials and then leaves their computer unattended, the present invention will help determine if the next input to occur is by that same user or an unauthorized/different individual.

Further, the present invention determines when a change of users of the device has occurred for the purpose of infection prevention in healthcare settings where cross-contamination via user interface devices is prevalent.

### BRIEF DESCRIPTION OF THE DRAWINGS

Preferred and alternative examples of the present invention are described in detail below with reference to the following drawings:

FIG. 1 is a block diagram of an exemplary system formed in accordance with an embodiment of the present invention; and

FIG. 2 is a data flow diagram of exemplary processes performed by the system shown in FIG. 1.

### DETAILED DESCRIPTION OF PREFERRED EMBODIMENTS

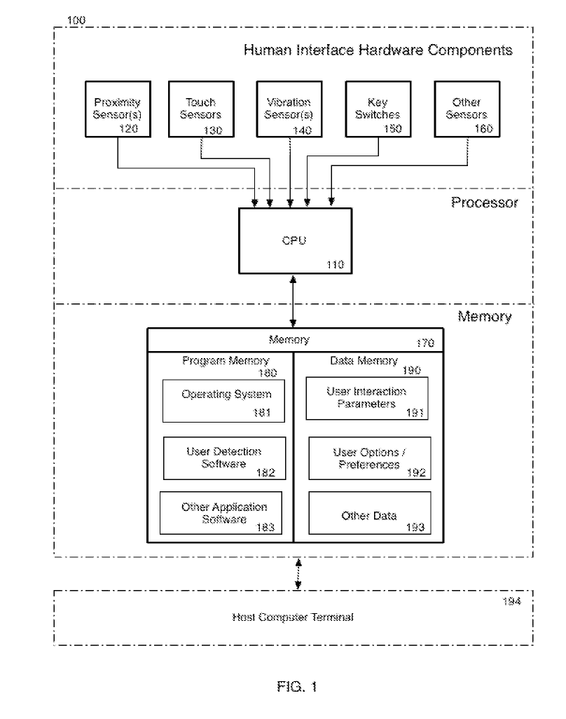

FIG. 1 shows a block diagram of an exemplary device 100 for providing text input that can discern user input actions such as tapping, resting, and pressing. The device 100 includes one or more touch sensors 120 that provide input to a CPU (processor) 110. The touch sensors 120 notify the processor 110 of contact events when a surface is touched. In one embodiment, the touch sensor(s) 120, or the processor 110, include a hardware controller that interprets raw signals produced by the touch sensor(s) 120 and communicates the information to the processor 110, using a known communication protocol via an available data port. The processor 110 is in data communication with a memory 170, which includes a combination of temporary and/or permanent storage, and both read-only and writable memory (random access memory or RAM), read-only memory (ROM), writable nonvolatile memory, such as FLASH memory, hard drives, floppy disks, and so forth. The memory 170 includes program memory 180 that includes all programs and software such as an operating system 181, user detection software component 182, and any other application software programs 183. The memory 170 also includes data memory 190 that includes System Settings 191, a record of user options and preferences 192, and any other data 193 required by any element of the device 100.

The device 100 detects at least four types of interactions from the user. First, the device 100 detects movement of a user's hands into the proximity of the device 100 sensed via proximity sensors 120. The proximity sensors 120 may be based on commonly used technology such as touch capacitance, infrared red, surface-acoustic way, Hall-effect, or optical sensors. The device 100 also detects touches from the user via touch sensors 130. The touch sensors 130 may be based on commonly used technology such as touch capacitance, infrared red, surface-acoustic way, resistive, or optical sensors. The device 100 can detect vibrations caused by user interaction via vibration sensors 140. The vibration sensors 140 may be based on commonly used technology such as accelerometers or piezo-acoustic sensors. Finally, the device 100 can detect key presses from the user via key switches 150. The key switches 150 may be based on commonly used switch technology. Other sensors 160 may also be incorporated to detect user interaction. For example, a camera may be used to detect user movement on or about the device 100.

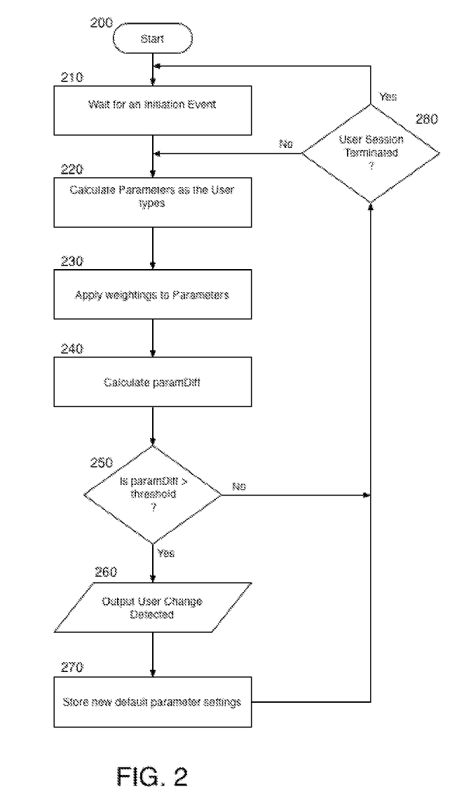

FIG. 2 shows an exemplary process performed by the device 100. The flowchart shown in FIG. 2 is not intended to fully detail the software of the present invention in its entirety, but is used for illustrative purposes. FIG. 2 shows a process 200 executed by the processor 110 based on instructions provided by the user detection software component 182. At block 210, the process waits for an initiation event, defined to be changing from a state of non-user-interaction to a state of user interaction. For example, the device 100 may have been idle with no user interaction for at least a period of time more than a minimum idle threshold, after which a human user interacts with the device in some way as detected by one or more of the sensors. The process then advances to block 220 where parameters related to the user interaction are stored. For example, the device 100 may store a user's typing characteristics such as typing speed and style, as well as numerous other attributes pertaining to the user which can help uniquely identify them. Examples of such parameters that may be detected and stored by the device 100 are included in the table below:

| Attribute | Description |
|---|---|
| Typing Style | By observing whether or not the user is resting their fingers |
| | on the user interface's surface, the speed of typing, and the |
| | capacitive signature, the typing style of the user can be |
| | determined between 10-finger touch typing, 2-finger “hunt |
| | and peck”, or some hybrid in between. |
| Typing Speed | Gross words per minute as determined over a reasonable |
| | sample of typing in a single session. |
| Finger Size | The degree to which the touch capacitance sensors are |
| | activated through a normal touch (“capacitive signature”). |
| Typing Cadence | Slow & steady vs. quick, short bursts |
| Typing accuracy | The number of mistakes made (as determined by |
| | backspaces). |
| Key location accuracy | The accuracy of the placement of fingers on the exact |
| | location of the keys (as opposed to in-between) |
| Spacebar Activation | Whether the spacebar is activated on the left, right, or |
| | middle of the key. |
| Modifier Key Use | Whether the opposite-hand modifier is used or not (for |
| | example, shift-F: is the left shift key activated or the right?) |
| Finger Rest Location | If the user rests their fingers, on which keys are they rested? |
| | (Not all 10-finger typists rest their fingers on the home row |
| | keys) |
| . Number Row Typing Speed | Not all experienced 10-finger typists can type on the number |
| | row without looking. So, the typing speed on this top row can |
| | be tracked separately. |
| . Time of Day | The time of day the user interface is used can often be |
| | correlated to specific users - especially in locations like |
| | hospitals that have work shifts. |
| . Tap strength: | The level of vibration generated at the accelerometer sensors |
| | as the user taps their finger on the surface of the user |
| | interface. |
| . Letter group Cadence | The propensity to type certain letter combinations in quick |
| | succession (eg. “ing”). |
| . Computer Login | Identifying the user explicitly via a login ID on the host |
| | computer to which the user interface is connected. |
| . Wipe pattern | When the user interface is wiped for cleaning, the wipe |
| | pattern can be user specific: some users may wipe top to |
| | bottom, others side to side, and so on. The speed of the |
| | wipes and number of iterations back and forth add to the |
| | uniqueness. |
| . Proximity Sensor | The strength of the wake-up pulse on the proximity sensor |
| . Proximity-to-Typing time | The time from a proximity-initiated wake-up to when the first |
| | key is typed on (are they quick and impatient, or more slow |
| | and steady in getting started?) |
| . Wake-up Key | Many users will press the same key to wake the user |
| | interface from a sleep state (eg. Space, right shift key, etc) |
| . Frequency of sleep cycles | Indicates the propensity of the user to continue to rest their |
| | fingers on the surface of the user interface while pausing |
| | between typing, or removing their hands causing the user |
| | interface to go to sleep. |
| . Key actuation times | The speed at which each individual key is pressed, held and |
| | released. |

The process continues in block 220 until a sufficient amount of user interaction data has been collected in order to determine at least a subset user-specific parameters listed in the table above. In block 230, different weightings are applied to the parameters according to user preferences stored in data memory 192. The weightings are required because the importance of each parameter in identifying a user may be different from environment to environment. For example, in a hospital setting, many users may type at approximately the same typing speed (and thus the typing speed parameter is given a lower weighting) whereas a change in the proximity parameter would strongly suggest a change in the user (and thus have a higher weighting).

The process continues in block 240 with a comparison of the user interaction parameters collected in block 200 with the interaction parameters associated with the previous period of active use. A cumulative difference in the compared parameter values is stored in a variable called paramDiff, with the appropriate weightings determined in block 230 applied. In block 250, the system determines if the paramDiff variable has exceeded a preset threshold. If it has, then a change of user is indicated which is communicated externally in block 260 to the host terminal 194, and the current user's interaction parameters are stored as the new default parameters in block 270 and the process continues to block 280. If the paramDiff variable has not exceeded the preset threshold then the process continues to block 280. At block 280, the system decides whether or not the user session has terminated. This would typically be indicated by a period of time of non-user-interaction that exceeds a minimum threshold. If the user session has not terminated, the process returns to block 220 where it continues to monitor user interaction parameters. If the user session has been terminated the process returns to block 210 where it awaits an initiation event.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for identifying a user of a user interface device, the method comprising:
at a processing device,
a) receiving at least one signal from one or more sensors associated with the user interface device;
b) identifying a user of the user interface device based on the received at least one signal and previously stored user parameter information
c) determining if the identified user is different than the most recently authenticated user; and
d) outputting a signal that indicates a user operation issue if the user is determined to be different than the most recently authenticated user; and
repeating at a-d) after a predefined delay.

2. The method of claim 1, wherein identifying further comprises comparing the received at least one signal to the previously stored user parameter information.

3. The method of claim 1, wherein the user interface device comprises a touch screen.

4. The method of claim 3, wherein the touch screen comprises a keyboard.

5. The method of claim 3, wherein the one or more sensors comprise at least one touch sensor, vibration sensor or proximity sensor.

6. The method of claim 5, wherein the touch sensor comprises at least one of a capacitive sensor or a resistive sensor.

7. The method of claim 5, wherein the previously stored user parameter information comprises vibration signatures.

8. The method of claim 5, wherein the previously stored user parameter information comprises at least one of finger rest signatures, vibration signatures, typing style information or typing speed information, time of day information.

9. The method of claim 1, further comprising:
identifying time-based user interaction characteristics associated with user operation of the user interface device,
wherein the previously stored user parameter information comprises time-based user interaction characteristics,
wherein identifying comprises identifying the user of user interface device further based on the identified time-based user interaction characteristics and the stored time-based user interaction characteristics.

10. A method for identifying a user of a user interface device, the method comprising:
at a processing device,
receiving at least one signal from one or sensors associated with the user interface device;
determining a change of users of the user interface device based on the received at least one signal and previously stored user parameter information; and
outputting a change of user signal if a change of users has been determined.

11. The method of claim 10, wherein determining further comprises comparing the received at least one signal to the previously stored user parameter information.

12. The method of claim 10, wherein the user interface device comprises a touch screen.

13. The method of claim 12, wherein the touch screen comprises a keyboard.

14. The method of claim 12, wherein the one or more sensors comprise at least one touch sensor, vibration sensor or proximity sensor.

15. The method of claim 14, wherein the touch sensor comprises at least one of a capacitive sensor or a resistive sensor.

16. The method of claim 14, wherein the previously stored user parameter information comprises finger rest signatures.

17. The method of claim 14, wherein the previously stored user parameter information comprises vibration signatures.

18. The method of claim 14, wherein the previously stored user parameter information comprises at least one of finger rest signatures, vibration signatures, typing style information or typing speed information, time of day information.

19. The method of claim 10, wherein outputting the change of user signal comprises at least one of illuminating an indicator or presenting an image on an associated display device.
